(19) United States
(12) Patent Application Publication
(10) Pub. No.: US 2026/0355854 A1
(43) Pub. Date: Nov. 12, 2026

(54) ADJUSTMENT DEVICE, MACHINING SYSTEM AND METHOD FOR ADJUSTING A RELATIVE POSITION OF A SAMPLE BEAM OF AN OPTICAL COHERENCE TOMOGRAPH AND A MACHINING BEAM OF A MACHINING SYSTEM

(71) Applicant: Lessmüller Lasertechnik GmbH, München (DE)

(72) Inventors: Eckhard Lessmüller, München (DE); Christian Truckenbrodt, Stockdorf (DE)

(73) Assignee: Lessmüller Lasertechnik GmbH, München (DE)

(21) Appl. No.: 19/530,137

(22) Filed: Feb. 4, 2026

(30) Foreign Application Priority Data
May 8, 2025 (DE) 10 2025 117 576.4

(51) Int. Cl. B23K 26/03; B23K 26/042; B23K 26/067; B23K 26/24

(52) U.S. Cl. CPC B23K 26/032; B23K 26/042; B23K 26/067; B23K 26/24

(57) ABSTRACT

The invention relates to an adjustment device for adjusting a relative position of a sample beam of an optical coherence tomograph and a machining beam of a machining system, in particular of a laser welding system, which are different regarding their light output as well as regarding their wavelength, comprising: an optical input port, through which the sample beam and the machining beam are jointly couplable; an image sensor configured to detect images and to generate image data; and an optical selector configured to feed the image sensor different portions of the sample beam and the machining beam, so that the machining beam as well as the sample beam are detectable with the image sensor. The invention further relates to a machining system and a method for adjusting a relative position of a sample beam of an optical coherence tomograph and a machining beam of a machining system.

### CROSS-REFERENCE TO RELATED APPLICATIONS

The present application claims priority from German Patent Application No. 10 2025 117 576.4, filed May 8, 2025, the entire disclosure of which is incorporated herein by reference.

### TECHNICAL FIELD

The invention relates to an adjustment device for adjusting a relative position of a sample beam of an optical coherence tomograph and a machining beam of a machining system, in particular of a laser welding system. The invention further relates to a machining system for machining a workpiece with a high-energy machining beam, in particular with a machining laser beam for welding, with an adjustment device. In addition, the invention relates to a method for adjusting a relative position of a sample beam of an optical coherence tomograph and a machining beam of a machining system, in particular of a laser welding system, which are different regarding their light output as well as regarding their wavelength.

### BACKGROUND

Devices that enable simultaneous monitoring of machining a workpiece during a machining process are known from prior art and are in particular used for laser welding processes. A high-energy machining beam in the form of a laser machining beam is used to, for example, connect two components of a workpiece in the area of a lap joint, a groove and/or a joining edge with each other.

Known devices sometimes have an optical coherence tomograph (OCT), which may scan the workpiece with a sample beam. Such systems then comprise an OCT sample scanner and a machining scanner, the coordinate systems of which have to be aligned congruently in all three spatial directions X, Y and Z while machining the workpiece. It is particularly challenging to ensure that the coordinate systems are aligned congruently at the beginning of machining the workpiece and to ensure that they remain aligned congruently during the whole machining process.

DE 10 2015 015 330 A1 discloses a device for monitoring a machining process carried out with a machining device, wherein the machining device comprises a machining beam source and machining beam optics and wherein the machining beam optics comprise a moveable first deflection device. The machining process is carried out along a predetermined main machining path on a workpiece by means of a high-energy machining beam that is moveable relative to the workpiece in a machining direction, which is transmitted by the machining beam source. The device comprises a sample device connected to the machining device or connectable to the sample device comprising an optical coherence tomograph with a sample beam source to carry out position measurements with a sample beam on the workpiece. The moveable first deflection device is configured to deflect the machining beam in an oscillating manner relative to the main machining path while machining along the main machining path, wherein the moveable first deflection device is further configured to deflect the sample beam. The sample device thereby carries out the position measurements with the sample beam by taking the deflection movement of the sample beam through the first deflection device into account. Monitoring the machining process is carried out automatically.

DE 10 2020 000 630 A1 discloses a method in which a sample beam is aligned with a machining beam by initially shooting a hole into a piece of aluminum foil or another metal with a machining beam and to subsequently detect the hole with the sample beam.

Furthermore, it is known from DE 10 2017 213 511 A1 to use a camera to record a high-resolution image of a portion of the workpiece surface to ascertain a position of a focus point of the laser beam. DE 10 2019 109 795 A1 uses a CCD camera to ascertain a beam diameter of a partial beam of a machining laser beam and uses the beam diameter to ascertain a focus position of the machining laser beam.

From the article “laser welding lattice to cell with in-process monitoring” by Al-Badani et al., which was published at the “European Automotive Laser Application” conference, it is known that heating a point on a component is used for congruent alignment of a coordinate system of an OCT sample scanner and an additional coordinate system of a machining scanner and to subsequently identify this point with a sample beam of the OCT sample scanner.

In summary, some known devices have automatic monitoring and/or configuration of a congruent alignment of the coordinate system of the OCT sample scanner and the additional coordinate system of the machining scanner. Automatic monitoring might be user-friendly and easy to handle, however, it might not be free of errors. In cases in which the OCT sample scanner, the machining scanner and/or another component of the system have an error that, for example cannot be detected and/or analyzed by controllers of this device, a more incorrect alignment of the coordinate system of the OCT sample scanner in relation to the coordinate system of the machining scanner might be caried out without noticing that the coordinate systems of the OCT sample scanner and the machining scanner are not aligned congruently.

In general, different methods of positioning a sample beam relative to the machining beam are known from prior art. These methods may be repeated periodically to check or adjust the correct positioning on a regular basis. One possibility is to shoot a hole in a piece of aluminum foil with a machining beam and to subsequently detect the hole with a suitable scan with the sample beam. A relative shift between the coordinate system of the machining beam and in particular its tool center point (TCP) and the coordinate system of the sample beam may then be determined from the determined data. The origin of the coordinates of the sample beam may then be set to the TCP of the machining beam. The main drawback of this method is the high manual time effort necessary for calibration and that a consumable is absolutely necessary for the process. In addition, the method is mainly suitable for initial adjustment. Only errors and deviations occurring during operation, which are thus dynamically occurring, may not be determined. If periodic measurements are to be carried out, the current machining process has to be interrupted and another test trial with aluminum foil has to be carried out.

A method for reference adjustment is described in DE 10 2018 000 887 A1. The basis is a partially reflecting optical element which is permanently integrated into the beam path of the sample beam. The method itself is based on determining the exact alignment of the sample beam by the fact whether the sample beam portions reflected when hitting the optical element lead to useable interference effects. In practice, this method of scanner calibration has proven to be easy but not sufficiently accurate to determine welding penetration depth. One reason for this is the fact that the method may only recognize deviations at a certain point in the beam path of the sample system. The calibration disc is attached directly behind the beam deflecting galvanometer motor to limit the optical aperture as little as possible. Thus, a change of the mechanical actuators and their bearings due to wear and temperature changes may be recognized and compensated for directly, however, the calibration method does not detect deviations from the target position, which are only recognized behind the calibration disc in the optical system. In addition, several optical as well as mechanical components that also have vital influence on the actual position of the OCT sample beam on the workpiece surface when the temperature changes are often located behind the deflection apparatus.

Another possibility to detect the offset between machining beam and sample beam is the additional integration of an optical sensor determining the location, such as a camera. A detailed description of the concept is described in DE 10 2015 012 565 B3. The integration of a camera leads to a more complex optical welding structure with bigger interference contours and increased weight. Another drawback is the complex incorporation of the information gained from image evaluation during the welding process and the increased calculating capacity of the sample system connected to it.

In DE 10 2018 219 129 B3, the calibration of the OCT sample beam onto the machining beam of a laser welding application via an aperture detector is described as well. To ascertain a translational offset between the machining and the sample coordinate system, an x-y-zero-offset-deviation of the machining beam relative to the aperture center is determined at the beginning. The aperture detector is thereby arranged on the workpiece supporting plane. This is done by scanning the aperture with the deflectable machining beam in an x-y-grid and by evaluating the laser output in every one of the grid points on a secondary detector surface, which is configured as a simple photodiode. Subsequently, the machining beam is angled exactly onto the aperture center and machining mirror scanners present are fixed. By subsequently scanning the aperture with the OCT sample beam, the sample coordinate system now may be recalibrated in relation to the machining coordinate system.

Based on the prior art, the invention is based on the object of verifying a correct orientation of sample beam and machining beam, in particular in an exact, reliable, cost-optimized manner and/or as necessary.

According to the invention, the object is achieved by an adjustment device, a machining system and a method as defined in the dependent and ancillary claims and as described herein. Further embodiments can be found in the dependent claims.

### DESCRIPTION OF THE INVENTION

The inventors realized that it is most advantageous to record an OCT sample beam and a machining beam together by means of an image sensor and show the user a recorded image of the beams to carry out and monitor the machining process. The inventors further realized that a high degree of compatibility with different systems and structures may be achieved by providing an adjustment device with an image sensor and a suitable optical attenuation. The adjustment device may be used as an individual device and may be integrated into a structure while having constructional and functional features that may be useable individually from the specific design of the sample setup and the machining system. This way, a cost-effective and simultaneously reliable system my be provided that may be used as required and thus allows it to quickly, accurately and regularly check the correctness of an adjustment of the machining beam position and the sample beam position and to correct them, if necessary. In addition, the user has the opportunity to quickly and intuitively recognize errors in the machining device, which might not be recognized with automated monitoring.

An adjustment device for adjusting a relative position, in particular a relatively lateral position, of a sample beam of an optical coherence tomograph and a machining beam of a machining system, in particular of a laser welding system, which are different regarding their light output as well as regarding their wavelength is described herein. The adjustment device comprises an optical input port, through which the sample beam and the machining beam are jointly couplable. The adjustment device further comprises an image sensor configured to detect images and to generate image data. In addition, the adjustment device comprises an optical selector configured to feed the image sensor different portions of the sample beam and the machining beam, so that the machining beam as well as the sample beam are detectable with the image sensor.

Moreover, a machining system for machining a workpiece with a high-energy machining beam, in particular a laser welding system for machining a workpiece with a high-energy machining laser beam, is described herein. The machining system comprises a machining apparatus with a machining beam source configured to create a machining beam. The machining system further comprises a sample apparatus for carrying out optical coherence tomography comprising a sample beam source configured to generate a sample beam and a sample beam displacement unit configured to displace the sample beam in a targeted manner corresponding to the workpiece, wherein the sample beam may be couplable into the machining beam. The machining system further comprises an adjustment device according to the invention.

In addition, a method for adjusting a relative position of a sample beam of an optical coherence tomograph and a machining beam of a laser welding system, which are different regarding their light output as well as regarding their wavelength, is described herein. The method is in particular carried out with an adjustment device according to the invention and/or with a machining system according to the invention. The method comprises the step of optical selection of a portion of the sample beam and a portion of the machining beam wherein the portions differ from each other and wherein the selected portions are fed to an image sensor. The method further comprises the step of detecting at least an image of the selected portions. Moreover, the method comprises the step of determining a position of a focal point of the machining beam and a position of a focal point of the sample beam. Moreover, the method further comprises the step of ascertaining a shift, in particular a lateral shift, of the focal point of the machining beam and the focal point of the sample beam in two dimensions. The method may comprise these steps in particular in the order mentioned.

By using the feature according to the invention, a correct orientation of sample beam and machining beam may be verified, in particular in an exact, reliable, cost-optimized manner and as necessary. Thus, with an adjustment according to the invention, it may be verified regularly if machining beam and sample beam are suitably aligned with each other or if, for example due to environmental influences or the like, the system needs to be repaired or if a deviation has occurred that could lead to inaccuracies in the measurements and the machining. Thus, the user may quickly prevent errors before and/or during the machining process from the outset or at least may recognize them and react accordingly. By using the machining device according to the invention, the user may recognize errors of the sample beam and the machining beam an automated evaluation might not recognize. Checking a correct positioning of both beams becomes intuitive.

The workpiece may comprise a first and a second component. The machining process may be a welding process. By means of the welding process, the first component of the workpiece may be connected with the second component of the workpiece by the high-energy machining beam. Within the scope of this disclosure, the term “laser welding” should be understood as general machining of a workpiece with a high-energy machining beam, in particular with a machining laser. This may also include laser drilling or laser cutting, for example.

The high-energy machining beam may be a laser beam. The laser beam may be pulsed and/or continuous and/or may show a continuous output. The machining beam may be targeted on one or several workpieces to carry out machining processes, in particular laser beam welding. A processing zone, in which the material of the workpiece is melted, forms at the area of incidence of the high-energy machining beam on the workpiece. As a result, a so-called keyhole may be formed. It is located within the melt pool and is formed by a vapor cavity, which is created by the interaction of the machining beam with the workpiece. The machining device source may be disposed on the machining device and/or in the machining device and/or may be spaced from the machining device.

The sample apparatus may comprise an optical coherence tomograph configured to generate the sample beam and a reference beam. The optical coherence tomograph may comprise a sample arm in which the sample beam is optically guidable, a reference arm in which the reference beam is optically guidable, a sample unit adapted to perform optical coherence tomography measurements by causing the sample beam and the reference beam to interfere to generate measurement data.

In particular, the sample beam may be targeted at the workpiece to measure the weld seam and/or the workpiece. A sample beam may be provided in particular to carry out measurements in the keyhole, for example to measure the welding penetration depth. Moreover, the sample beam may be provided to carry out measurements in front of, behind and/or next to a current machining position, for example at selected measurement positions. They may follow a specific pattern and may, for example, be on one or several sample lines, for example parallel, transverse or oblique relative to a machining direction. A well-tried set up provides coupling the sample beam into the machining beam and leads the sample beam and the machining beam essentially coaxial onto the workpiece via a joint optic. A sample beam displacement unit, in particular a sample scanner, may be used to displace the sample beam in a targeted manner relative to the machining beam, so that a current sample location may be actively different from a current machining position. The sample beam displacement unit may in particular comprise a repositionable mirror arrangement. For example, the sample beam displacement unit may have at least one and in particular two movable mirrors by means of which the sample beam may be displaced in a targeted manner. The sample beam displacement unit may be an acousto-optical modulator (AOM), through which the sample beam may be displaced.

The machining apparatus may comprise a machining beam displacement unit configured to displace the machining beam in a targeted manner corresponding to the workpiece. This may for example be a machining scanner with which the machining beam may be displaceable relative to the workpiece. The machining beam displacement unit may allow a machining position on the workpiece to be displaced in at least one or two spatial directions. The machining beam displacement unit may in particular comprise a repositionable mirror arrangement. For example, the machining beam displacement unit may have at least one and in particular two movable mirrors by means of which the machining beam may be displaced in a targeted manner. The machining beam displacement unit may be an acousto-optical modulator (AOM) through which the machining beam may be displaced. In embodiments with a machining beam displacement unit, the sample beam may be guided by the sample beam displacement unit as well as by the machining beam displacement unit, whereas the machining beam may only be guided by the machining beam displacement unit in this case. Thus, the sample beam is displaced by the machining beam displacement unit as well as by the sample beam displacement unit, however, the machining beam may only be displaced by the machining beam displacement unit.

The machining system may comprise a machining head, which, for example, may be attached to an industrial robot. The machining head my be moveable relative to the workpiece, wherein the relative movement may be created by moving the machining head and/or moving the workpiece. The machining apparatus may further comprise a focusing apparatus. This may comprise a focusing lens, in particular a F-Theta-lens or be configured as such. The machining beam and the sample beam coupled into the machining beam may then be jointly projected and/or focused onto the workpiece or a working area of the machining system by using the focusing lens.

The sample apparatus may comprise a sample head attached to the machining head. In some embodiments, the sample apparatus may at least be partly integrated into the machining head. The sample beam displacement unit may be in particular secured in or attached to the machining head and/or may be moveable together with the machining head.

Some embodiments may be configured without a machining beam displacement unit or without machining scanner. An optical path of the machining beam may then be for example invariable relative to the machining head. A movement of the machining beam relative to the workpiece may be carried out, for example, by suitable relative movement of the machining head and the workpiece, for example by using the aforementioned industrial robot.

The machining system may define a clamping plane on which the workpiece may be attached for machining. The machining system may comprise a workpiece carrier, for example in the form of a table, a carrier, a tension apparatus or the like. The workpiece carrier may define a clamping plane.

The adjustment device is preferably configured as a self-contained device. The adjustment device may be placed on the workpiece carrier and/or may be fastened to it. In some embodiments, the adjustment device may be a permanent and/or stationary component of the machining system. In other embodiments, the adjustment device may be configured to be attached to and/or placed temporarily on the workpiece carrier by the user in a manual manner to carry out the adjustment. In this case, the adjustment device may be removed during machining.

The optical input port of the adjustment device for example comprises an optical window that may be covered with glass. However, it may also be a hole.

The image sensor is in particular a two-dimensional image sensor with a pixel array, for example an image chip. This may, for example, be a CMOS sensor or a CCD sensor. The image sensor is preferably a monochrome sensor, however, it may also be a color sensor, for example a color sensor such as a RGB chip or the like. However, it has become apparent that a monochrome sensor is also able to sufficiently distinguish between the sample beam and the machining beam, so that their respective positions may be found reliably on the image sensor.

The image sensor may have a resolution of at least 480 pixels, in particular of at least 720 pixels, preferably of at least 800 pixels and especially preferred of at least 1000 pixels along the first side of the image. The image sensor may have a resolution of at least 640 pixels, in particular of at least 1280 pixels, preferably of at least 1440 pixels and especially preferred of at least 1600 pixels along the second side of the image. The image sensor may have a pixel size of no more than 10 µm, in particular no more than 8 µm, preferably no more than 6 µm and especially preferred no more than 4 µm. At a pixel size of a few micrometers, positioning deviations between the sample beam and the machining beam may be determined with a sufficiently high accuracy. Thus, it has been shown, for example, that a positioning with an accuracy of approx. 4 µm is also sufficient for measurements in the keyhole to be able to carry out measurements inside the keyhole reliably during machining.

The image sensor is in particular configured to directly detect the sample beam and the machining beam. In other words: the sample beam and the machining beam fall onto pixel of the image sensor after suitable attenuation and selection by the optical sensor and are thus directly image detectable. Unlike, for example, in the case of position measurement with a quadrant photodiode, no relative measurements of light intensity are necessary but a real image of the focal point of the sample beam and the machining beam may be recorded. This image may then be displayed to the user and/or processed further by suitable image processing to determine the position of the sample beam and the machining beam.

The optical selector is in particular configured to mitigate the machining beam. The machining beam usually has a significantly higher light intensity and/or output than the sample beam. The output of the sample beam lies usually within the range of a few milliwatt, whereas the output of the machining beam may be several hundred watts. The outputs may differentiate for example by at least 4, in particular by at least 5, preferably by at least 6 and in a few cases by at least 7 magnitudes. The optical selector may be configured to feed a portion of the machining beam to the image sensor, which is mitigated by at least 60 dB, in particular by at least 70 dB, in some cases by at least 80 dB and in some cases by at least 90 dB or even by at least 100 dB compared to the machining beam coupled into the optical input port.

The optical sensor may be carried out wavelength selective. Typically, the wavelength of the sample beam differs from the wavelength of the machining beam. The machining beam may for example have a wavelength between 1000 nm and 1100 nm, for example if the machining beam is generated with a Nd:YAG laser. However, the wavelength range may be selected differently, for example based on the kind of machining laser. A carbon dioxide laser may be used as well, for example. Preferably, the sample beam comes from a low coherency broadband light source such as a super luminescent diode. If the sample beam and the machining beam spectra overlap, the optical selector may be expediently set to the wavelength of the machining beam selectively, for example in the manner of a notch filter. Even if the sample beam is then mitigated in the respective wavelength range as well, the intensity of the sample beam outside of the mitigated range is still sufficient to be able to deflect it.

The optical sensor is preferably configured to feed the image sensor a portion of the sample beam and a portion of the machining beam in such a way that the output and/or light intensity of the portions differs by factor 100 at most, in particular by a factor 50 the most, preferably by a factor 10 at most and especially preferably by a factor 5. The portions not fed to the image sensor may thus differ in a correspondingly significant manner.

A controlled and targeted mitigation of the machining beam for its image detection with the image sensor might be achieved in particular if the adjustment device further comprises an absorber wherein the optical selector is configured to feed the absorber a portion of the machining beam, which is larger than the portion of the machining beam fed to the image sensor. According to the explanations above, the portion fed to the absorber may be larger by a factor that corresponds to the achievable mitigation of the machining beam. The absorber may comprise a beam dump, for example.

In some embodiments, the optical selector may be a wavelength selective dichroic beam splitter. This way, the desired mitigation may be carried out in a selective and reliable way. The beam splitter may in particular be a notch filter or an edge filter. If designed as a notch filter, the beam splitter may be partially transparent in a wavelength range by an intensity maximum of the machining laser. The mentioned mitigation of the machining beam may be achieved by the fact that a majority of machining beams pass through the beam splitter and for example hit the absorber, whereas a smaller portion is deflected and fed to the image sensor. Allowing the machining beam to pass through or deflecting it may then happen in accordance with the mitigation mentioned. At the same time, a majority of the sample beam may be deflected by the beam splitter instead. In alternative embodiments, the beam splitter may deflect the majority of the machining beam and feed the deflected portion to the absorber. The small portion that has passed through may then hit the image sensor directly. To use an available installation space efficiently, the deflection of the portion that has to be detected has proven to be suitable, since a lateral optical path may then be used for focusing onto the image sensor, whereas the machining beam may also hit the absorber in a defocused way.

In addition, it may be provided that the adjustment device further comprises an adjustable optical attenuator disposed between the optical selector and the image sensor and which is configured to optionally mitigate the machining beam and/or the sample beam. The optical attenuator may comprise a plurality of optical filters, which may mitigate the sample beam and/or the machining beam further in a targeted way after the selection has been made. Thus, the adjustment device may be adjusted to different machining and sample situations. This way, it may be used with different machining beam outputs and/or sample beam outputs as well as with different beam diameters or focuses.

A high degree of longevity and/or reliability may be achieved in particular if the adjustment device comprises a housing with a moveable lid configured to optionally uncover or cover the optical input port. The moveable lid may be attached pivotally to the base body housing. In some embodiments, the lid may be an aperture, for example an iris aperture. The adjustment device may comprise an actuator for the lid, which is configured to move the lid automatically to uncover and cover the optical input port.

In some embodiments, the adjustment device may comprise an image sensor carrier carrying the image sensor and by means of which at least two different positions of the image sensor, which define different optical path lengths from the input port to the image sensor, are adjustable. The image sensor carrier may for example comprise one or several rails along which the image sensor may be moveable automatically and/or manually. This way, an optical path length from the optical input port to the image sensor may be repositionable. For a given setup position and/or installation position of the adjustment device an optical way to the image sensor corresponding to an optical path up to the clamping plane of the workpiece in its length may be adjustable this way. Measurements carried out with the adjustment device thus may be conveyed to the real machining situation immediately.

The desired adjustment may in particular be carried out in a simple, reliable and exact way if the adjustment device comprises an evaluation unit configured to evaluate image data of the image sensor and to determine a position of a focal point of the machining beam and a position of a focal point of the sample beam based on image analysis. The positions may for example be detectable by means of automatic detection of a center point of an image of the sample beam and a center point of an image of the machining beam.

The evaluation unit is further configured to ascertain a relative shift of the focal point of the machining beam and the focal point of the sample beam in two dimensions. This way, a shift necessary for an adjustment may be determined quickly and reliably. A measurement with the adjustment device thus produces an x-value and a y-value as a result, which indicate a shift between machining beam and sample beam, respectively. Thus, this may correspond to a shift of the origin of the coordinate system of the sample beam relative to the TCP of the machining beam.

Expediently, a measurement is carried out with the adjustment device by setting the sample beam and the machining beam to the origin in their respective coordinate system or at least to a predetermined, specific sample position or machining position. It may then be checked if the predetermined positions show the expected spatial relation or if they are located in a way that deviates from it. The machining beam is, for example, set onto the TCP. Moreover, the sample beam is set onto the TCP. It is thus expected that both beams are to be recognizable congruently by the image sensor. If this is not the case, a corresponding deviation provides conclusions to a relative shift of the coordinate systems, which may then be compensated for with a suitable adjustment.

Correspondingly, the method according to the invention may comprise a step of setting a relative shift of a machining beam coordinate system and a sample beam coordinate system in two dimensions in accordance with either the ascertained relative shift of the machining beam or the sample beam in two dimensions.

The machining system may comprise a control apparatus which is connected to the machining apparatus, the sample apparatus and the adjustment device. A machining beam position may be predetermined based on a machining beam coordinate system. In addition, a sample beam position may be predetermined based on a sample beam coordinate system. The control apparatus may be configured to set a relative shift of the machining beam coordinate system and the sample beam coordinate system in two dimensions based on a relative shift of the machining beam and the sample beam in two dimensions ascertained by the adjustment device. This way, adjustment measurements may be transferred to an adjustment efficiently and with high accuracy.

In some embodiments, the machining system has a user interface with a display on which an image representing the adjustment measurement result may be shown to a user. For example an overlapping representation may be shown to the user on which an image of the machining beam, an image of the sample beam and a fade-in of a measured offset are depicted. The user interface may further comprise input means with which the user may confirm the correctness of the offset detected and/or may approve an adjustment that is to be carried out.

As described above, the machining system may comprise a workpiece carrier on which and/or at which the workpiece for machining may be attachable. The adjustment device may be moveable on the workpiece carrier instead of the workpiece to carry out an adjustment. For example, a user may attach and/or arrange the adjustment device in such a way that the machining beam and the sample beam fall onto the optical input port instead of onto the workpiece. Expediently, the adjustment device is configured in such a way that a length of an optical path from the machining head to the image sensor corresponds to a length of an optical path from the machining head to the clamping plane of the workpiece.

The machining beam and the sample beam may be jointly displaceable at a position of the adjustment device to carry out the adjustment. This may be achieved by moving the adjustment device to a suitable position. Alternatively or additionally, a position of the adjustment device may be approached with the industrial robot. The adjustment device may be permanently installed and/or disposed at a certain position. Thus, to carry out the adjustment, a workpiece may then remain clamped and the machining head may be moved to the adjustment device with the industrial robot. It may be assumed that an actuation accuracy of the industrial robot is at least sufficiently high to ensure that even if there is an offset between the coordinate system of the machining beam and the coordinate system of the sample beam, both beams fall into the optical input port. Since actuation errors of the industrial robot impact the machining head and thus similarly the machining beam and the sample beam, an adjustment carried out this way may in particular compensate an offset occurring due to the sample beam displacement unit and/or the machining beam displacement unit. In other words: the movement of the industrial robot does not necessarily impact the offset that has to be adjusted. In this case, mounting the adjustment device to a fixed position may be useful. For other applications, however, moving the adjustment device itself, for example by a user, may generate the most reliable readings.

In particular, it is pointed out that all features and properties described with respect to devices as well as procedures can be applied mutatis mutandis to methods according to the invention and are applicable in the sense of the invention and deemed to be disclosed. The same applies vice versa. This means that structural features, i.e. features according to the device mentioned with respect to methods can also be taken into account, claimed as well as deemed to be disclosed within the scope of the device claims.

### BRIEF DESCRIPTION OF THE DRAWINGS

Subsequently, the present invention is described by way of example with reference to the attached figures. The drawing, the description and the claims contain numerous features in combination. The skilled person will expediently consider the features individually as well and use them sensibly in combination within the scope of the claims.

In the drawings:

FIG. 1 is a schematic representation of a machining apparatus and a sample apparatus;

FIG. 2 is a schematic representation of a machining situation of a machining system;

FIG. 3 is a schematic representation of an adjustment situation of the machining system;

FIG. 4 is a schematic representation of an adjustment device of the machining system;

FIG. 5 is a schematic representation of an adjustment representation shown on a display device for a user; and

FIG. 6 is a schematic flow chart for adjusting a relative position of a sample beam of an optical coherence tomograph and a machining beam of a laser welding system.

### DETAILED DESCRIPTION OF THE INVENTION

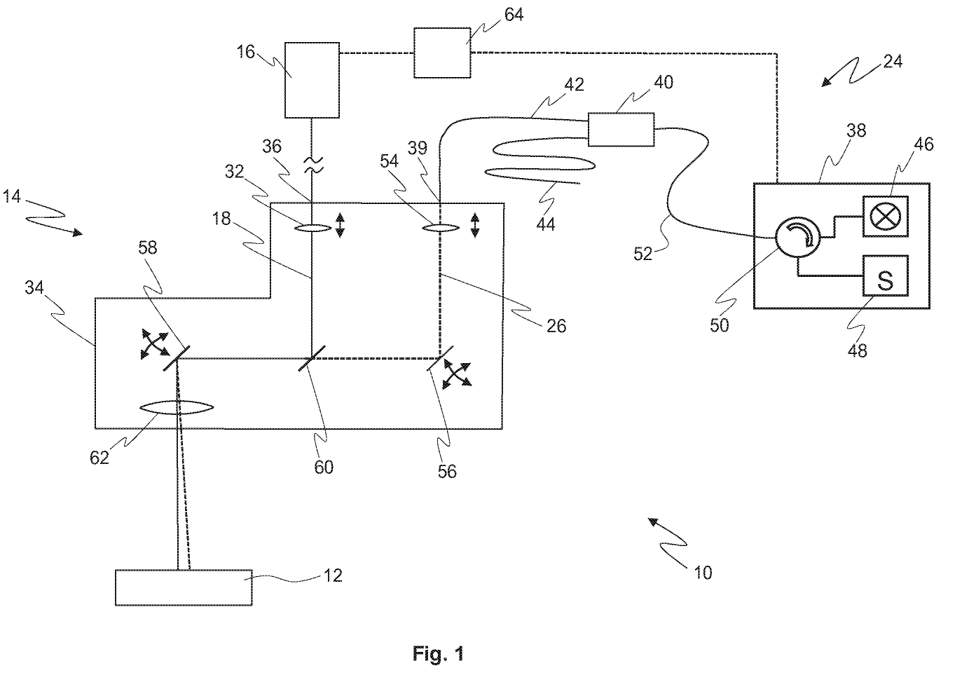

FIG. 1 shows a schematic representation of a device 10 for machining a workpiece 12 and for carrying out optical coherence measurements to monitor a machining process. The workpiece 12 may, for example, be a sheet metal part or another component made from metal, as is a combination of several parts that are to be connected, in particular welded, for example during machining. The device 10 comprises a machining apparatus 14 with a machining beam source 16 that generates a high-energy machining beam 18. In the case illustrated, the machining beam source 16 comprises a laser that generates a machining laser beam. The machining apparatus 14 may comprise a repositionable collimation lens 32.

In the example shown, the machining apparatus 14 comprises a machining head 34. The machining beam 18 may be coupled into the machining head 34 via an interface 36 of the machining head 34. For example, the machining beam 18 may be guided to the machining head 34 by an optical fiber. In the case shown, the machining head 34 is disposed on an industrial robot (not shown), with which the machining head 34 is moveable relative to the workpiece 12. In other embodiments, the workpiece 12 may be moveable alternatively or additionally.

The device 10 further comprises a sample apparatus 20 comprising an optical coherence tomograph 24 with an OCT meter 38 that is connected with a sample arm 42 and a reference arm 44 via a beam splitter 40.

The OCT meter 38 is configured with a sample beam source 46 to generate a sample beam 26 as well as a spectrometer 48 to detect an overlapping sample radiation. Moreover, the OCT meter 38 may comprise a circulator 50 that connects the beam splitter 40 with the sample beam source 46 or the spectrometer 48 via a fiber or a light pipe 52, depending on the movement direction of the incoming light.

The sample arm 42 of the optical coherence tomograph 24 extends to the workpiece 12. The sample arm 42 may comprise a repositionable collimation lens 54. Furthermore, an interface 39 via which the sample beam 26 is coupled into the machining head 34 may be provided.

The device 10 comprises a sample beam displacement unit 56 in the form of a sample scanner. In the illustrated example, the sample beam displacement unit 56 comprises two moveable mirrors that are pivotable in two different spatial directions. This way, the sample beam 26 may be displaced in a targeted manner.

The device 10 further comprises a machining beam displacement unit in 58 the form of a machining scanner. In the illustrated example, the machining beam displacement unit 58 is part of the machining apparatus 14. The machining beam displacement unit 58 makes it possible to displace the machining beam 18 in two spatial directions. Expediently, the machining beam displacement unit 58 comprises two mirrors arranged behind each other along the optical path of the machining beam 18, which are pivotably in one spatial direction respectively. By moving both mirrors, a displacement of the machining beam 18 in one plane may occur. The machining beam 18 may be displaced with the machining beam displacement unit 58, so that a focal point on the workpiece 12 may be changed.

The machining apparatus 14 comprises a partially transparent mirror 60. It directs the machining beam 18 onto the machining beam displacement unit 58. Moreover, the sample beam 26 passes through the partially transparent mirror 60 and also meets the machining beam displacement unit 58. The sample beam 26 is thus couplable into the machining beam 18. The sample beam 26 and the machining beam 18 are jointly displaceable via the machining beam displacement unit 58. Since the sample beam 26 may be displaceable via the sample beam displacement unit 56 as well, the focal point of the sample beam 26 on the workpiece 12, meaning a sample position 28, may be displaced relative to the focal point of the machining beam 18 and independently of the machining beam 18 on the workpiece 12. Thus, measurements are possible at a current machining position as well as on different sample positions 28 differentiating from this. In particular, different sample positions 28 may be set, for example along the sample lines or at certain individual points.

The device 10 further comprises focusing optics 62. In some cases, the focusing optics 62 may comprise a F-Theta-lens disposed behind the machining scanner 58. Alternatively or additionally, pre-focusing optics may be provided, for example directly in front of the machining scanner 58. The machining beam 18 and the sample beam 26 both pass through the focusing optics 62.

This may show that, starting from the beam splitter 40, the sample arm 42 extends to the focal point of the sample beam 26 on the workpiece 12. Regarding its optical characteristics, in particular regarding its optical distance and/or its dispersion, the reference arm 44 is adjusted to the sample arm 42. Thus, distance values may be determined via OCT in a known manner by overlapping of the light running in the sample arm 42 or the reference arm 44.

The machining system 10 comprises a control unit 64. The control unit 64 may be a central control unit that controls the machining apparatus 14 as well as the optical coherence tomograph 24. Alternatively or additionally, individual and/or separate control units may be provided. The control unit 64 or the control units comprise at least a processor as well as a memory to temporarily and/or permanently store raw data, preprocessed data, evaluated data, program code and the like. The functions of the control unit 64 will be discussed again below. It is understood that the functions of the device 10 and its components mentioned as well as the methods mentioned are carried out by the control unit 64. Moreover, a computer program product not shown is provided, comprising instructions that are executable by the control unit to carry out the control functions mentioned. The computer program product may in particular comprise a non-volatile storage medium on which the instructions are stored.

The aforementioned explanations serve the basic understanding of the mode of operation of the machining apparatus 14 and the sample apparatus 10. It is further described below how an adjustment may be carried out.

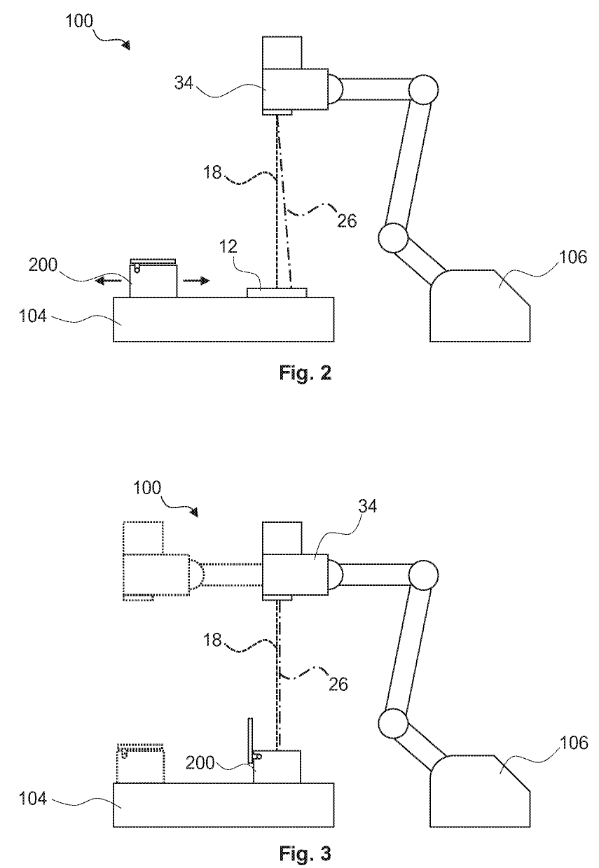

FIG. 2 shows a schematic representation of a machining situation of a machining system 100 In the machining system 100, the machining apparatus 14 described and the sample apparatus 20 described are used. The machining system 100 further comprises an industrial robot 106 carrying the machining head 34. The machining head 34 comprises the components described above, with which the machining beam 18 and the sample beam 26 may be jointly pointed at the workpiece 12 to carry out laser machining such as laser welding and to carry out measurements, for example to monitor processes and/or plan paths.

The machining system 100 further comprises a workpiece carrier 104 onto which the workpiece 12 may be clamped. A surface of the workpiece 12 that needs machining is thus located in a clamping plane. The machining beam 18 and the sample beam 26 are focused towards it. As shown schematically in FIG. 2, the machining head 34 may be moved relatively to the workpiece 12 with the industrial robot 106. Thus, a machining path may be traced. In addition, the machining beam 18 may be deflected by the machining beam displacement unit 58 in the present case. As noted above, other embodiments in which the machining beam 18 is only displaceable by moving the machining head 34 are possible as well.

Moreover, it is schematically shown in FIG. 2 that the machining beam 18 and the sample beam 26 may be directed at different positions. This may be achieved, for example, by displacing the sample beam 16 via the sample beam displacement unit 56 relative to the machining beam 18. For example, the sample beam 26 in FIG. 2 is directed at a position that is located behind the machining beam 18 in the machining direction, for example to scan the weld seam created. Alternatively or in temporal alternation, the area in front of the machining beam 18 and/or the keyhole created may be scanned.

Irrespective of the scanning mode, control of the position of the sample beam 26 and the machining beam 18 is carried out by setting the positions in a suitable coordinate system. They are coordinated with each other in such a way that they are in a set spatial relation to each other, in particular relating to the origins and/or the orientation and/or the movement of their axes. In the present case, matching coordinate origins may for example be selected, meaning that the origin of the coordinate system for the sample beam 26 corresponds to the TCP of the machining beam 18. The axes may be chosen correspondingly, meaning that the corresponding x-axes and y-axes are parallel. It is thus to be understood that other spatial relations may be used as well.

However, it is decisive that the set positions act as expected in an external reference coordinate system, in particular in the clamping plane. If corresponding positions are chosen, the sample beam 26 and the machining beam 18 should fall onto the same position. However, deviations are possible, for example due to temperature drifts or due to other external or internal factors. It is thus provided that adjustment measurements are to be carried out before machining and/or in certain, for example regular, time intervals during the machining and, if necessary, carry out an adjustment to compensate for an undesired shift between the coordination systems.

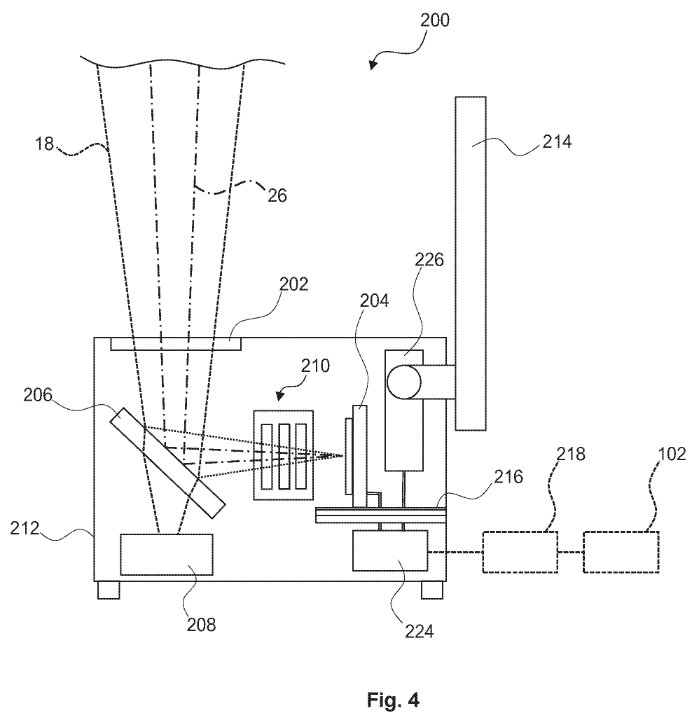

The machining system 100 comprises an adjustment device 200 for this purpose, which is subsequently described in more detail with reference to FIG. 4. In the present case, the adjustment device 200 is moveable and may be set up and/or clamped onto the workpiece carrier 104. This is shown as an example in FIG. 3, which shows a schematic representation of an adjustment situation of the machining system 100. The adjustment device 200 is positioned in such a way that it is located in a machining area of the machining system 100, in which the workpiece 12 may be expanded during machining. For example, the adjustment device 200 may be positioned in such a way that it is located at an origin of the different coordinate systems of the sample apparatus 20, the machining apparatus 14 and, in addition, potentially the industrial robot 106. By using the adjustment device 200, it may then be measured whether there is an offset between the sample beam 26 and the machining beam 18 that needs to be compensated for.

If machining is carried out before or after the adjustment, the adjustment device 200 may be put aside, such as for example shown in FIG. 2.

In alternative embodiments, the adjustment device 200 may be placed permanently at or onto the workpiece carrier 104, for example in a different position, such as for example shown in FIG. 2. The machining head 34 is then moved to the position of the adjustment device 200 for adjustment with the industrial robot 106. The adjustment measurements are carried out at this position. Such a situation is shown with dashed lines in FIG. 3 as an alternative to the moveable adjustment device 200. Since potential actuating inaccuracies of the industrial robot 106 impact the machining beam 18 and thus similarly the sample beam 16, as they are jointly decouplable from the machining head 34 via the industrial robot 106, those actuating errors are irrelevant for relative position errors of the machining beam 18 and the sample beam 26.

FIG. 4 shows a schematic representation of the adjustment device 200. The adjustment device 200 comprises a housing 212 with an optionally moveable lid 214. In the present case, the lid 214 is moveable with an actuator 226. Thus, the lid 214 may be opened automatically for adjustment measurements. However, the adjustment device 200 may otherwise be closed to protect its inner workings.

The adjustment device 200 comprises an optical input port 202 through which the sample beam 26 and the machining beam 18 are jointly couplable. In the present case, the input port 202 is a glass panel. An optical selector 206, with which different portions of the sample beam 26 and the machining beam 18 may be selected in a targeted manner, is disposed behind the optical input port 202. In the present case, the optical selector 206 is configured as a partially transparent mirror with wavelength selective coating. It is translucent in the area of a wavelength of the machining beam 18 and only redirects a very small portion in this area. Thus, the majority of the machining beam 18 passes through the optical selector 206 and may hit an absorber 208 of the adjustment device 200. In the present case, the absorber 208 is configured as a beam dump.

Thus, a dampening of the machining beam 18 is achieved, for example of 70 dB, 80 dB, 90 dB or even 100 dB. This may account for the fact that an output of the machining beam 18 is several magnitudes bigger than an output of the sample beam 26.

However, a significantly larger portion of the sample beam 26 is redirected in the present case. For example, the sample beam 26 is a broadband and low-coherence beam, so that in the wavelength range of the transparency of the optical selector 206, the sample beam 26 mostly passes through the optical selector 206 and hits the absorber 208, however, above and/or below this wavelength range the sample beam 26 is mostly redirected undampened.

In the present case, the optical selector 206 is for example transparent to wavelengths above a wavelength limit, for example for wavelength above 900 nm. Below 900 nm, components of the sample beam 26 but not of the machining beam 18 may be found, so that a large portion of the sample beam 26 is being redirected. However, only a very small amount of the machining beam 18, the wavelength of which is for example between 1000 nm and 1100 nm in the case of a Nd:YAG laser, is being redirected, whereas the majority passes through to the absorber 208.

Moreover, the adjustment device 200 comprises an image sensor 204 that is attached to an optical image sensor carrier 216 in the present case. The redirected portions of the machining beam 18 and the sample beam 26 are directed to the image sensor 204, so that images of those may be detectable. Despite the very different outputs of the beams, this is made possible by matching the intensity of the beams by means of the optical selector 206. Thus, the machining beam 18 does not exceed the sample beam 26 but both may be image detectable in a distinguishable way.

An optical path length from the optical input port 202 to the image sensor 204 is preferably sized in such a way that the sample beam 26 and the machining beam 18 may be focused on the image sensor 204 when entering the adjustment device 200. A distance from the machining head 34 to the image sensor 204 thus corresponds to a distance from the machining head 34 to the clamping plane. To be able to achieve this for different installation situations of the adjustment device 200, the image sensor carrier 216 may have an adjustment possibility. For example, the image sensor carrier 216 may comprise one or several rails, along which the image sensor 204 may be slidable. The image sensor 204 may be infinitely or gradually adjustable and/or set at a target position.

Deflection with the optical selector 206 has the advantage that a lower height of the adjustment device 200 may be achieved, even if those considerations are taken into account regarding the optical path length. However, embodiments in which the sample beam 26 and the machining beam 18 pass through the optical selector 206 and hit the image sensor 204 are conceivable as well. A deflected portion is then fed to the absorber 208.

It has turned out to be expedient for both configurations to provide a perpendicular incident of the beams onto the optical input port 202 and the image sensor 204. Thus, image errors due to the angle may be avoided. In addition, a potential slight defocus is less severe, since the respective beam center may be determined reliably even if the image of the sample beam 26 and the machining beam 18 is slightly out of focus.

Moreover, it has proven to be expedient if the adjustment device 200 also comprises an optical attenuator 210, with which the machining beam 18 and/or the sample beam 26 may be attenuated in a targeted manner. This may be a filter carrier, for example, a slider or a filter wheel. Thus, the adjustment device 200 may be adjusted to different input outputs. The attenuator 210 may for example comprise bandpass filters, notch filters and neutral density filters. Optionally and with priority or only the sample beam 26, with priority or only the machining beam 18 or both beams may be mitigated in a targeted manner by this to set the respective beam output to a level on which the sample beam 26 as well as the machining beam 18 may be detected with the image sensor 204.

The adjustment device 200 also comprises a printed circuit board 224 with which the image sensor 204, the actuator 226 and potentially an actuator (not shown) of the attenuator 210 may be connected.

The adjustment device 200 further comprises an evaluation unit 218, which may be implemented internally or externally. The evaluation unit 218 may be a software product. The evaluation unit 218 is configured to ascertain a relative shift of a focal point of the machining beam 18 and a focal point of the sample beam 126 in two dimensions. The evaluation unit 218 is further connected with a control apparatus 102 of the machining system 100. For example, the control apparatus 102 may be a central computer, with which different components of the machining system 100 are controllable. This means that the evaluation unit 218 may be integrated into the control apparatus 102 and/or, for example, may be a computer program executable on said computer.

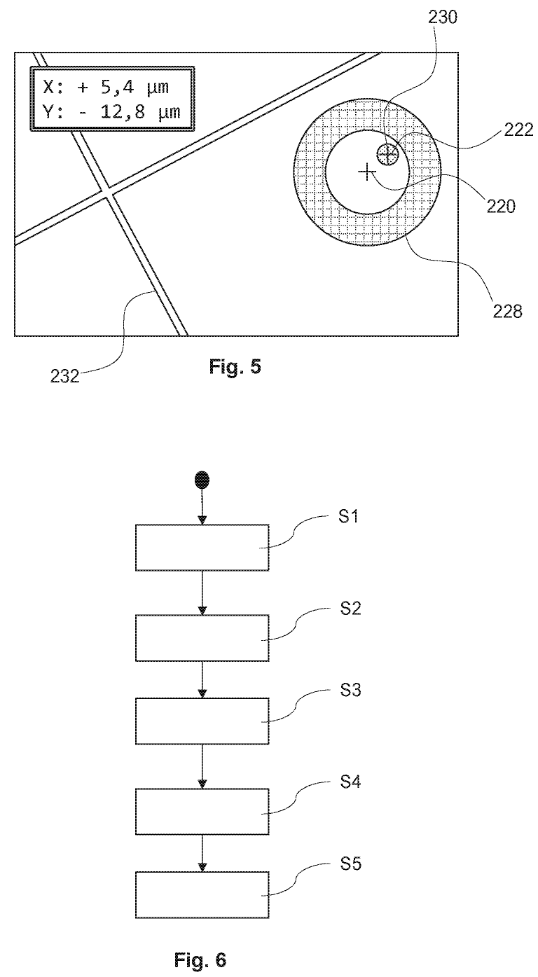

FIG. 5 is a schematic representation of an adjustment representation shown on a display device for a user.

Initially, an image 232 of an optional target structure is displayed on the adjustment representation. Such a target structure may be located at the optical input port 202 and may be scannable with the sample beam 26. The target structure may be, for example, configured as a recess or relief for this purpose. For example, the target structure may be configured as a cross and may be detectable by the sample beam 26 through scanning. This scan may comprise a grid or a simple scan along two lines running transverse or oblique to each other. It may also be a single line. Before carrying out an adjustment measurement, the target structure may be scanned. Since the orientation of the target structure on the housing 212 is known to the adjustment device 200, the image 232 of it may allow an automatic detection of a relative rotation of the adjustment device 200. The user then does not have to align the adjustment device 200 at the x-direction and the y-direction of the machining system 100 when positioning the adjustment device 200 is positioned on the workpiece carrier 104.

It is thus understood that the image of the target structure is not generated with the image sensor 204. However, it is also not detected with the image detection of the sample beam 26 and the machining beam 18 but prior with an OCT scan. It is then overlapped with the image that is recorded with the image sensor 204. Thus, the user may receive visual feedback regarding the alignment and/or positioning of the adjustment device.

In some embodiments, the image of the target structure may be used to straighten up the representation shown to the user. This may be accomplished after a confirmation by the user, for example. A straightened-up representation may be understood by the user more intuitively, since the sides of the representation then run parallel to the x-axis and the y-axis.

Moreover, an image 230 of the sample beam 26 and an image 228 of the machining beam 18 are recognizable in the representation. Center points 222, 220 of the same may be found automatically by image recognition and may be shown to the user by using markings, in the present case crosses are used for example. In the present case, the machining beam 18 is recognizable as a ring, which is due to the passage of the machining beam 18 through an optical fiber. The image of the machining beam 18 is thus also an image of the inside of the fiber. This may be different in other embodiments.

It is immediately recognizable from the representation that there is a spatial offset between the sample beam 26 and the machining beam 18. In the present case, they were, for example, directed at the origin of the coordinates or at the TCP of the machining beam 18, however, due to deviations both beams do not match exactly. In the top left corner of the representation, as is shown by way of example in FIG. 5, a value of an x-offset and a value of an y-offset may be shown in addition. In the present case, those values are determined automatically based on the images 228, 230.

In some embodiments, image recognition is not necessary. A user may then manually ascertain the x-offset and/or the y-offset by adapting the target position of the sample beam 26 and/or the machining beam 18 manually until the two beam centers match sufficiently.

The determined offset of both beams may then be taken into account by the control apparatus 102 if positions for the machining beam 18 and/or the sample beam 26 are predetermined. Thus, an adjustment may be carried out to compensate for potential deviations.

FIG. 6 shows a schematic flow chart for adjusting a relative position of a sample beam 26 of an optical coherence tomograph 24 and a machining beam 18 of a machining system 100. The operation of the method follows from the aforementioned description. By way of example, the method is described with reference to the machining system 100 described.

The method comprises a step S1 of optical selection of a portion of the sample beam 26 and a portion of the machining beam 18 wherein the portions differ from each other and wherein the selected portions are fed to an image sensor 204.

The method further comprises a step S2 of detecting at least an image of the selected portions.

Moreover, the method comprises a step S3 of determining a position of a focal point 220 of the machining beam 18 and a position of a focal point 222 of the sample beam 26.

The method further comprises a step S4 of ascertaining a shift of the focal point 220 of the machining beam 18 and the focal point 222 of the sample beam 26 in two dimensions.

In addition, the method may comprise a step S5 of setting a relative shift of a machining beam coordinate system and a sample beam coordinate system in two dimensions in accordance with either the ascertained relative shift of the machining beam 18 or the sample beam 26 in two dimensions.

### LIST OF REFERENCE SIGNS

10 device
12 workpiece
14 machining apparatus
16 machining beam source
18 machining beam
20 sample apparatus
24 optical coherence tomograph
26 sample beam
34 machining head
36 interface
38 OCT meter
39 interface
40 beam splitter
42 sample arm
44 reference arm
46 sample beam source
48 spectrometer
50 circulator
54 collimation lens
56 sample beam displacement unit
58 machining beam displacement unit
60 semi-transparent mirror
62 focusing optics
64 control apparatus
100 machining system
102 control apparatus
104 workpiece carrier
106 industrial robot
200 adjustment device
202 optical input port
204 image sensor
206 optical selector
208 absorber
210 attenuator
212 housing
214 lid
216 image sensor carrier
218 evaluation unit
220 focal point
222 focal point
224 printed circuit board
226 actuator
228 image of the machining beam
230 image of the sample beam
232 target structure
234 image of the target structure

What is claimed is:

1. Adjustment device for adjusting a relative position of a sample beam of an optical coherence tomograph and a machining beam of a machining system, in particular of a laser welding system, which are different regarding their light output as well as regarding their wavelength, comprising:
an optical input port, through which the sample beam and the machining beam are jointly couplable;
an image sensor configured to detect images and to generate image data; and
an optical selector configured to feed the image sensor different portions of the sample beam and the machining beam, so that the machining beam as well as the sample beam are detectable with the image sensor.

2. The adjustment device of claim 1, further comprising an absorber, wherein the optical selector is configured to feed the absorber a portion of the machining beam, which is larger than the portion of the machining beam fed to the image sensor.

3. The adjustment device of claim 1, wherein the optical selector is a wavelength selective dichroic beam splitter.

4. The adjustment device of claim 1, further comprising an adjustable optical attenuator disposed between the optical selector and the image sensor and which is configured to optionally mitigate the machining beam and/or the sample beam.

5. The adjustment device of claim 1, further comprising a housing with a moveable lid configured to optionally uncover or cover the optical input port.

6. The adjustment device of claim 1, further comprising an image sensor carrier carrying the image sensor and by means of which at least two different positions of the image sensor, which define different optical path lengths from the input port to the image sensor, are adjustable.

7. The adjustment device of claim 1, further comprising an evaluation unit configured to evaluate image data of the image sensor and to determine a position of a focal point of the machining beam and a position of a focal point of the sample beam based on image analysis.

8. The adjustment device of claim 7, wherein the evaluation unit is configured to ascertain a relative shift of the focal point of the machining beam and the focal point of the sample beam in two dimensions.

9. Machining system for machining a workpiece with a high-energy machining beam, comprising:
a machining apparatus comprising a machining beam source configured to create a machining beam;
a sample apparatus for carrying out optical coherence tomography comprising a sample beam source configured to generate a sample beam and a sample beam displacement unit configured to displace the sample beam in a targeted manner corresponding to the workpiece, wherein the sample beam may be couplable into the machining beam; and
an adjustment device of claim 1.

10. Machining system of claim 9, wherein the machining apparatus has a machining beam displacement unit configured to displace the machining beam in a targeted manner corresponding to the workpiece.

11. Machining system of claim 9, comprising a control apparatus connected to the machining apparatus, the sample apparatus and the adjustment device,
wherein the machining beam position may be predetermined based on a machining beam coordinate system,
wherein the sample beam position may be predetermined based on a sample beam coordinate system; and
wherein the control apparatus may be configured to set a relative shift of the machining beam coordinate system and the sample beam coordinate system in two dimensions based on a relative shift of the machining beam and the sample beam in two dimensions ascertained by the adjustment device.

12. Machining system of claim 9, further comprising a workpiece carrier on which and/or at which the workpiece may be attached for machining;
wherein the adjustment device is moveable on the workpiece carrier instead of the workpiece to carry out an adjustment.

13. Machining system of claim 9,
wherein the machining beam and the sample beam are jointly displaceable at a position of the adjustment device to carry out the adjustment.

14. Method for adjusting a relative position of a sample beam of an optical coherence tomograph and a machining beam of a machining system, in particular of a laser welding system, which are different regarding their light output as well as regarding their wavelength, carried out in particular by means of an adjustment device according to claim 1, comprising the following steps:
optical selection of a portion of the sample beam and a portion of the machining beam wherein the portions differ from each other and wherein the selected portions are fed to an image sensor;
detecting at least an image of the selected portions;
determining a position of a focal point of the machining beam and a position of a focal point of the sample beam; and
ascertaining a shift of the focal point of the machining beam and the focal point of the sample beam in two dimensions.

15. Method according to claim 14,
further comprising the following step:
setting a relative shift of a machining beam coordinate system and a sample beam coordinate system in two dimensions in accordance with either the ascertained relative shift of the machining beam or the sample beam in two dimensions.
